(19) United States
(12) Patent Application Publication
(10) Pub. No.: US 2005/0270466 A1
(43) Pub. Date: Dec. 8, 2005

(54) LIQUID CRYSTAL DISPLAY MODULE

(76) Inventors: Pao-Yun Tang, Tao-Yuan Hsien (TW); Shu-Lin Ho, I-Lan Hsien (TW); Kei-Hsiung Yang, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,617

(22) Filed: Sep. 29, 2004

(30) Foreign Application Priority Data
Jun. 8, 2004 (TW) 093116427

(51) Int. Cl. G02F 1/1345

(52) U.S. Cl. 349/149

(57) ABSTRACT

A liquid crystal display module manufactured by a chip-on-glass technology includes at least one glass substrate having a display area and a peripheral area. A plurality of scan and data lines is separately formed on the display area along horizontal and vertical directions. The liquid crystal display module also includes at least one gate driver chip and at least one source driver chip mounted on the peripheral area. The gate and source driver chips transmit signals to the scan and data lines via a plurality of output terminals, and thicknesses of the gate and source driver chips are less than 0.3 mm.

### BACKGROUND OF INVENTION

1. Field of the Invention

The invention relates to a liquid crystal display module, and more particularly, to a liquid crystal display module manufactured by chip-on-glass technology.

2. Description of the Prior Art

Chip-on-glass (COG) technology is a module assembling technology for constructing a liquid crystal display with high pin count and fine pitch. The gate driver chips or the source driver chips are directly mounted on a glass substrate with anisotropic conductive film. This kind of assembling technology provides fewer contact points between the signal sources of the gate or source driver chips and the pixels, and can improve the reliability of the product.

The thickness of the anisotropic conductive film is chosen according to the height of a gold bump on the contact points, for example, when the height of the gold bump is 15 to 18 μm, the thickness of the anisotropic conductive film is 23 to 25 μm. The amount of the gate or source driver chips used in the COG technology is decided by the resolution of the product and the output pins of the driver chips. For an XGA (1024×768) liquid crystal display, if the source driver chip has 384 maximum output pins and the gate driver chip has 256 maximum output pin, 8 source driver chips and 3 gate driver chips are required when performing the COG technology.

Please refer to FIG. 1, which is a schematic diagram of a liquid crystal display module manufactured with the COG technology according to the prior art. The liquid crystal display module 100 has two glass substrates 102 and 104 arranged in parallel, where the glass substrate 102 is a color filter substrate and the glass substrate 104 is a thin film transistor substrate. The liquid crystal display module 100 can be divided into two areas: a display area 120 and a peripheral area 130. The source driver chips 106 and the gate driver chips 108 are formed on the peripheral area 130 of the glass substrate 104. The source driver chips 106 and the gate driver chips 108 are adhered onto the gold bump (not shown) on the glass substrate 104 with the anisotropic conductive film, and the adhered temperature of the anisotropic conductive film is about 170 to 190° C.

Please refer to FIG. 2, which is a cross section of a liquid crystal display module manufactured with the COG technology according to the prior art. FIG. 2 shows the detail of the COG structure of the liquid crystal display module 100. The gate driver chip 108 is mounted onto the glass substrate 104 with the anisotropic conductive film 110, and at least one flexible printed circuit board 112 is mounted on the peripheral area 130 for transferring control signals.

Since the coefficients of thermal expansion of the source driver chip 106, the gate driver chip 108, the glass substrate 104, and the anisotropic conductive film 110 are different, the contact points on surface of the glass substrate 104 will have a residual stress when cooling down from the high temperature to room temperature. As shown in FIG. 3, the residual stress causes the warpage of the glass substrate 104, and curtain mura appears near the contact points of the source driver chips 106 and the gate driver chips 108. FIG. 4 shows the curtain mura that causes the image near the contact points of the source driver chips 106 and the gate driver chips 108 to be uneven. The warpage of the glass substrate 104 will cause optoelectronic defects.

### SUMMARY OF INVENTION

It is therefore a primary objective of the claimed invention to provide a liquid crystal display module that can reduce warpage of the glass substrate to solve the above-mentioned problem.

According to the claimed invention, a liquid crystal display module manufactured by a chip-on-glass technology is disclosed. The liquid crystal display module includes at least one glass substrate having a display area and a peripheral area. A plurality of scan and data lines is separately formed on the display area along horizontal and vertical directions. The liquid crystal display module also includes at least one gate driver chip and at least one source driver chip mounted on the peripheral area. The gate and source driver chips transmit signals to the scan and data lines via a plurality of output terminals, and thicknesses of the gate and source driver chips are less than 0.3 mm.

According to the claimed invention, another liquid crystal display module manufactured by a chip-on-glass technology is further disclosed. The liquid crystal display module includes at least one glass substrate having a display area and a peripheral area. A plurality of scan and data lines is separately formed on the display area along horizontal and vertical directions. The liquid crystal display module also includes at least one gate driver chip and at least one source driver chip mounted on the peripheral area. The gate and source driver chips transmit signals to the scan and data lines via a plurality of output terminals, and the gate and source driver chips are bendable.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a liquid crystal display module manufactured with the COG technology according to the prior art.

FIG. 2 is a cross section of a liquid crystal display module manufactured with the COG technology according to the prior art.

FIG. 3 is a schematic diagram of warpage of the glass substrate according to the prior art.

FIG. 4 is a schematic diagram of a curtain mura of the liquid crystal display module according to the prior art.

FIG. 5 is a schematic diagram of a liquid crystal display module manufactured with COG technology according to the present invention.

FIG. 6 is a cross section of a liquid crystal display module manufactured with COG technology according to the present invention.

FIGS. 7 and 8 are the relational charts of the driver thickness and the warpage degree.

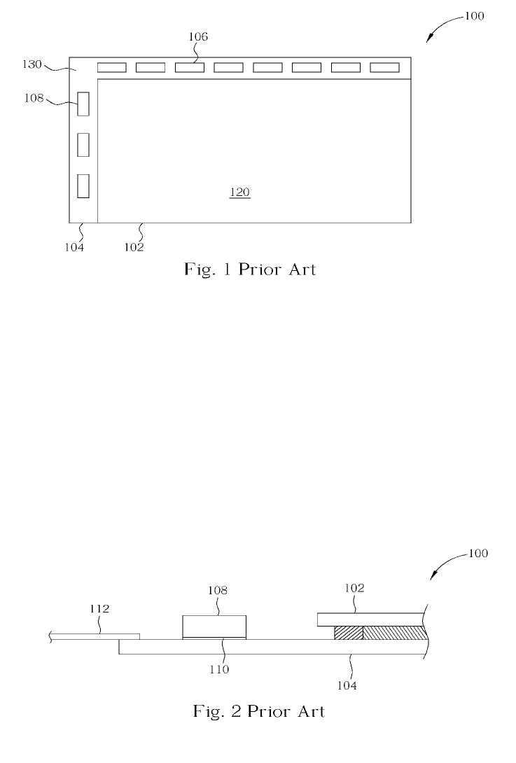

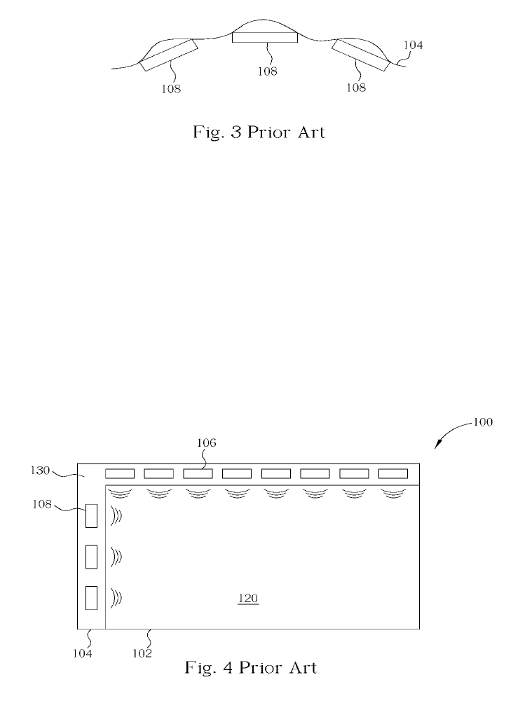

### DETAILED DESCRIPTION

The present invention provides a liquid crystal display module manufactured with the COG technology whose gate and source driver chips are bendable. If the coefficients of thermal expansion of the source/gate driver chips and the glass substrate are different, the residual stress caused by the contact points cooling down from high temperature to room temperature will be counteracted by bending the source/gate driver chips, and the warpage of the glass substrate will be mitigated. After mitigating the warpage, the curtain mura will be also improved.

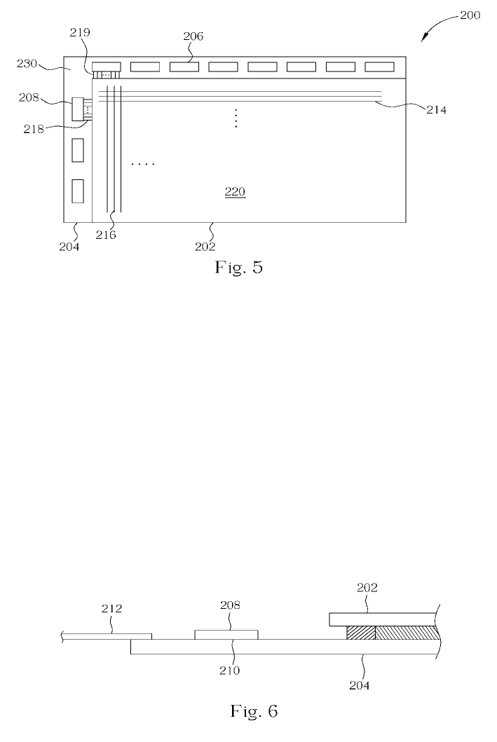

Please refer to FIGS. 5 and 6, which are a schematic diagram and a cross section of a liquid crystal display module manufactured with COG technology according to the present invention. In FIG. 5, the appearance of the liquid crystal display module 200 is similar to that of the liquid crystal display module 100. The difference is that the gate driver chips 208 and the source driver chips 206 used in the liquid crystal display module 200 are bendable, and the gate driver chips 108 and the source driver chips 106 used in the liquid crystal display module 100 are not.

As shown in FIGS. 5 and 6, the liquid crystal display module 200 includes two glass substrates 202 and 204 arranged in parallel, where the glass substrate 202 is a color filter substrate, for example, and the glass substrate 204 is a thin film transistor substrate. The liquid crystal display module 200 can be also divided into two areas: a display area 220 and a peripheral area 230. A plurality of scan lines 214 and a plurality of data lines 216 are formed on the display area 220 along horizontal and vertical directions on the thin film transistor substrate. The source driver chips 206 and the gate driver chips 208 are formed on the peripheral area 230 of the glass substrate 204. The source driver chips 206 and the gate driver chips 208 are adhered on the glass substrate 204 with an adhesive material. The adhesive material is an snisotropic consuctive film 210, for example, or a non-conductive film filled between bumps (not shown). At least one flexible printed circuit board 212 is mounted on the peripheral area 230 for transferring control signals. The gate driver chip 208 transmits signals to the scan lines 214 via a plurality of output terminals 218, and the source driver chip 206 transmits signals to the data lines 216 via a plurality of output terminals 219. When adhering the source driver chips 206 and the gate driver chips 208 to the glass substrate 204, many kinds of adhesive materials can be chosen, and the anisotropic conductive film 210 is one of them.

The conventional source driver chips 106 and the gate driver chips 108 are made from a semiconductor wafer, and are generally hard and cannot be bent. After mounting the conventional source and gate driver chips 106, 108 onto the glass substrate 104 and cooling down to room temperature, the glass substrate 104 will be bent. However, when the thickness of the semiconductor wafer is reduced to a specific degree, the physical properties will change and a bendable ability will be obtained. The present invention reduces the thickness of the source driver chips 206 and the gate driver chips 208 to make them bendable. When the thickness of the source driver chips 206 and the gate driver chips 208, which are primarily made of silicon, is less than 0.3 mm, they will be bendable, and the residual stress will be effectively counteracted.

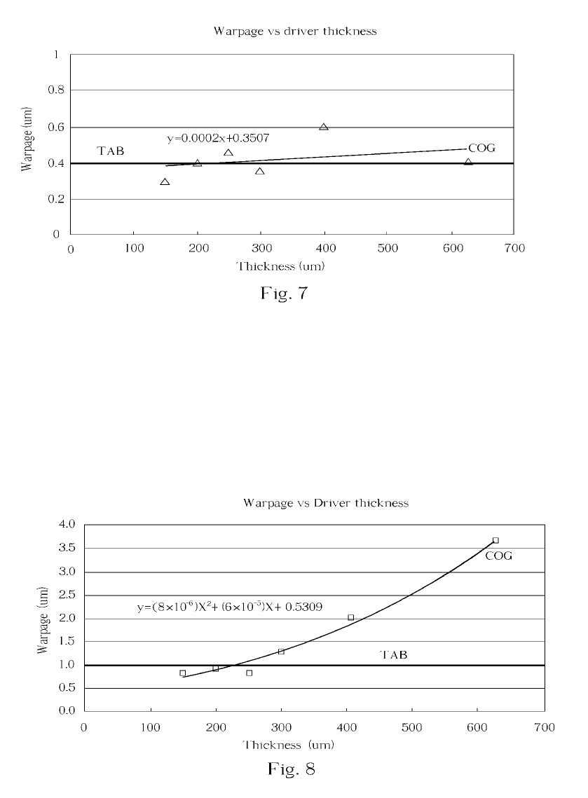

For verifying the relationship between the warpage of the glass substrate and the driver thickness, the applicant has performed a series of experiments under different conditions, and FIGS. 7 and 8 shows the result. When the thickness of the driver chip is gradually reduced and the thickness of the glass substrate is fixed as 0.63 mm, the warpage of the glass substrate will be also gradually reduced. FIG. 7 is a relational chart of the driver thickness and the warpage occurring between two contact points, and FIG. 8 is a relational chart of the driver thickness and the warpage occurring under the contact point.

In FIGS. 7 and 8, the present invention is compared with a liquid crystal display module manufactured with the tape automated bonding (TAB) technology. The TAB technology mounts the driver chips onto the external flexible printed circuit board, which occupies more capacity and increases weight of the whole module. However, the driver chips of the TAB technology are not directly mounted on the glass substrate and never induce the curtain mura defect. In FIGS. 7 and 8, six driver chips with different thickness are mounted onto the glass substrates, and the warpage degree is measured. The regression curves and the regression equations are obtained from FIGS. 7 and 8, and are compared with the warpage degree of the TAB technology. When using the TAB technology, the warpage occurring between two contact points is 0.4 μm, and the warpage occurring under the contact point is 1.0 μm. Hence, according to the regression curves and the regression equations of FIGS. 7 and 8, when the thickness of the driver chip is less than 300 μm, the warpage occurring between two contact points will be near or less than 0.4 μm, and the warpage occurring under the contact point will be near or less than 1.0 μm. In other words, when the silicon thickness of the driver chip is less than 0.3 mm, the warpage degree of the glass substrate manufactured with the COG technology will be similar to that manufactured with the TAB technology. This result verifies that when the silicon thickness of the source driver chip 206 and the gate driver chip 208 is less than 0.3 mm, the warpage of the glass substrate 204 can be diminished, and the curtain mura can be reduced.

In contrast to the prior art, the present invention utilizes bendable gate/source driver chips to manufacture a liquid crystal display module so that curtain mura can be effectively improved and the defect can be reduced. While the present invention includes driver ICs made of silicon of thickness less than 0.3 mm, other material of different hardness and coefficient of thermal expansion can also be chosen, as long as a proper thickness, which allows the driver ICs to be bendable, of silicon is chosen.

Those skilled in the art will readily observe that numerous modifications and alterations of the device may be made while retaining the teachings of the invention. Accordingly, the above disclosure should be construed as limited only by the metes and bounds of the appended claims.

1. A liquid crystal display module comprising:
a glass substrate having a display area and a peripheral area, a plurality of scan lines and a plurality of data lines is separately formed on the display area along horizontal and vertical directions;
at least a gate driver chip mounted on the peripheral area, the gate driver chip transmits signals to the scan lines via a plurality of output terminals, and thickness of the gate driver chip is less than 0.3 mm; and
at least a source driver chip mounted on the peripheral area, the source driver chip transmits signals to the data lines via a plurality of output terminals, and thickness of the source driver chip is less than 0.3 mm.

2. The liquid crystal display module of claim 1, wherein the gate driver chip and the source driver chip are mounted on the glass substrate with a chip-on-glass technology.

3. The liquid crystal display module of claim 1, wherein the gate driver chip and the source driver chip are mounted on the glass substrate with an adhesive material.

4. The liquid crystal display module of claim 3, wherein the adhesive material includes an anisotropic conductive film.

5. The liquid crystal display module of claim 1 further comprising at least a flexible printed circuit board mounted on the peripheral area.

6. A liquid crystal display module comprising:
a glass substrate having a display area and a peripheral area, a plurality of scan lines and a plurality of data lines are separately formed on the display area along horizontal and vertical directions;
at least a gate driver chip mounted on the peripheral area, the gate driver chip transmits signals to the scan lines via a plurality of output terminals, and the gate driver chip is bendable; and
at least a source driver chip mounted on the peripheral area, the source driver chip transmits signals to the data lines via a plurality of output terminals, and the source driver chip is bendable.

7. The liquid crystal display module of claim 6, wherein the gate driver chip and the source driver chip are mounted on the glass substrate with a chip-on-glass technology.

8. The liquid crystal display module of claim 6, wherein thickness of the gate driver chip is less than 0.3 mm.

9. The liquid crystal display module of claim 6, wherein thickness of the source driver chip is less than 0.3 mm.

10. The liquid crystal display module of claim 6, wherein the gate driver chip and the source driver chip are mounted on the glass substrate with an adhesive material.

11. The liquid crystal display module of claim 10, wherein the adhesive material includes an anisotropic conductive film.

12. The liquid crystal display module of claim 6 further comprising at least a flexible printed circuit board mounted on the peripheral area.
